(19) United States
(12) Patent Application Publication
(10) Pub. No.: US 2006/0222879 A1
(43) Pub. Date: Oct. 5, 2006

(54) Aluminum-silicon diffusion coated alloy products

(76) Inventors: George T. Bayer, Tarentum, PA (US); Kim A. Wynns, Spring, TX (US)

Correspondence Address: BUCHANAN INGERSOLL & ROONEY PC, P.O. BOX 1404, ALEXANDRIA, VA, 22313-1404, US

(21) Appl. No.: 10/616,712

(22) Filed: Jul. 10, 2003

Related U.S. Application Data
(63) Continuation-in-part of application No. 08/745,199, filed on Nov. 8, 1996, now Pat. No. 6,592,941.

(51) Int. Cl. B22D 25/00; B32B 15/01

(52) U.S. Cl. 428/610; 428/650; 428/939

(57) ABSTRACT

Aluminum-silicon diffusion coated alloy products have a surface of aluminum-silicon diffusion coating of greater than 180 microns thick formed on workpieces made from an iron, nickel, cobalt or copper base alloys. Preferably the diffusion coating has a thickness of at least 200 to 250 microns.

### CROSS REFERENCE TO RELATED APPLICATION

This is a continuation-in-part of U.S. patent application Ser. No. 08/745,199 filed Nov. 8, 1996.

### FIELD OF INVENTION

The invention relates to an iron, nickel, cobalt, or copper base alloy with an aluminum-silicon containing coating diffused onto the surface of the alloy using a pack cementation process.

### BACKGROUND OF THE INVENTION

Pack cementation is a well known technique for applying diffusion coatings to metal surfaces. This process involves placing a pack mixture into close contact with the surface being coated and subsequently heating the entire assembly to an elevated temperature for a specified period of time. During heating the coating material diffuses from the pack onto the surface of the metal by a combination of chemical reactions and gas phase mass transport. Pack cementation is commonly used to apply aluminum diffusion coatings as well as to apply chromium diffusion coatings. A common pack mixture used to create a chromium coating contains chromium, an inert filler such as alumina, and a halide activator. Similarly a common pack mixture used to produce an aluminum coating consists of an aluminum source, a halide salt activator and an inert diluent or filler such as alumina. Davis in U.S. Pat. No. 4,904,501 teaches that ammonium chloride, sodium chloride and ammonium bromide can be used as activators.

Aluminum-silicon diffusion coatings are preferred over aluminum diffusion coatings for some applications because silicon in the coating improves hot corrosion and ash corrosion resistance and reduces brittleness of the coating. The art has developed several methods of applying an aluminum-silicon coating to ferrous metal articles. Most commercial processes that are used to apply aluminum-silicon diffusion coatings require separate diffusion steps for each element or use expensive masteralloys. Masteralloys of aluminum and silicon cost 3 to 4 times more than pure aluminum and twice as much as pure silicon on a weight basis. Consequently, those skilled in the art have been searching for a less expensive process, particularly one in which an aluminum-silicon diffusion coating is applied in a single step. Preferably, the process should not require any materials that are expensive or difficult to obtain. The process should be suitable for use on existing equipment and for large scale processing operations. Both U.S. Pat. No. 4,500,364 and No. 4,310,574 discloses processes in which a slurry coating is applied to the article followed by high temperature firing. Slurries are more difficult to handle than the more common powder mixtures used in most pack cementation processes.

Krutenat in U.S. Pat. No. 4,500,364 discloses an aluminum-silicon slurry containing from 0.5 to 2.0% by weight sodium chloride activator. As will be seen from data presented herein, the coating thickness produced using this mix never exceeded 180 microns (7 mils) and was as thin as 80 microns (3 mils). Indeed, we are not aware of any prior art aluminum silicon diffusion coatings which have a thickness greater than 180 microns. Coatings less than 180 microns thick are not acceptable for many industrial applications. The petrochemical/chemical processing industry, for example, often demand coating thickness at least 200 microns (8 mils) or more.

Japanese Patent application 54090030 discloses a process in which steel plate is buried in an agent comprised of aluminum powder, silica (SiO₂) powder and a halide and then heated at 1000° C. in a nonoxidizing atmosphere to apply an aluminum and silicon diffusion coating. Because of the low reactivity of the silica powder, the resulting coating would contain very little silicon. Therefore, the benefits of having silicon in an aluminum diffusion coating are not obtained.

### SUMMARY OF THE INVENTION

We provide iron-, nickel-, cobalt- and copper-based alloy products having an aluminum-silicon coating which is greater that 180 microns (7 mils) thick and preferably at least 200 to 250 microns. Indeed, using the process disclosed here even thicker coatings can be achieved. We form this coating by simultaneous deposition of aluminum and silicon using a pack mix containing pure aluminum, pure silicon and an ammonium halide activator. The components to be coated are placed in a carbon steel or high temperature alloy retort and the surfaces to be coated are covered by the pack mix. The retort may be heated to between 150° to 200° C. (300° to 400° F.) for one hour or longer to remove any oxygen or moisture present. Then the retort is heated to an interior temperature of 650° to 1150° C. (1200° to 2100° F.) and held at that temperature for a selected time period. That time period will depend upon the base alloy being coated and the required depth of the diffusion coating. After the selected heating period has passed the retort is rapidly cooled and opened. Then the aluminum-silicon diffusion coated parts are removed. The coated parts are then cleaned and, if desired, also abrasive blasted.

### BRIEF DESCRIPTION OF THE FIGURES

FIG. 1 is a perspective view of a retort partially cut away which contains tubular products and our pack for applying an aluminum-silicon diffusion coating in accordance with a first preferred embodiment of our method; and

FIG. 2 is a perspective view similar to FIG. 1 of a retort partially cut away which contains tubular products and our pack for applying an aluminum silicon-diffusion coating in accordance with a second preferred embodiment of our method.

FIG. 3 is a perspective view similar to FIG. 1 where a pack mix with added binder is contained in a composite ceramic sheet placed adjacent to surfaces of plates to be coated.

### DESCRIPTION OF THE PREFERRED EMBODIMENTS

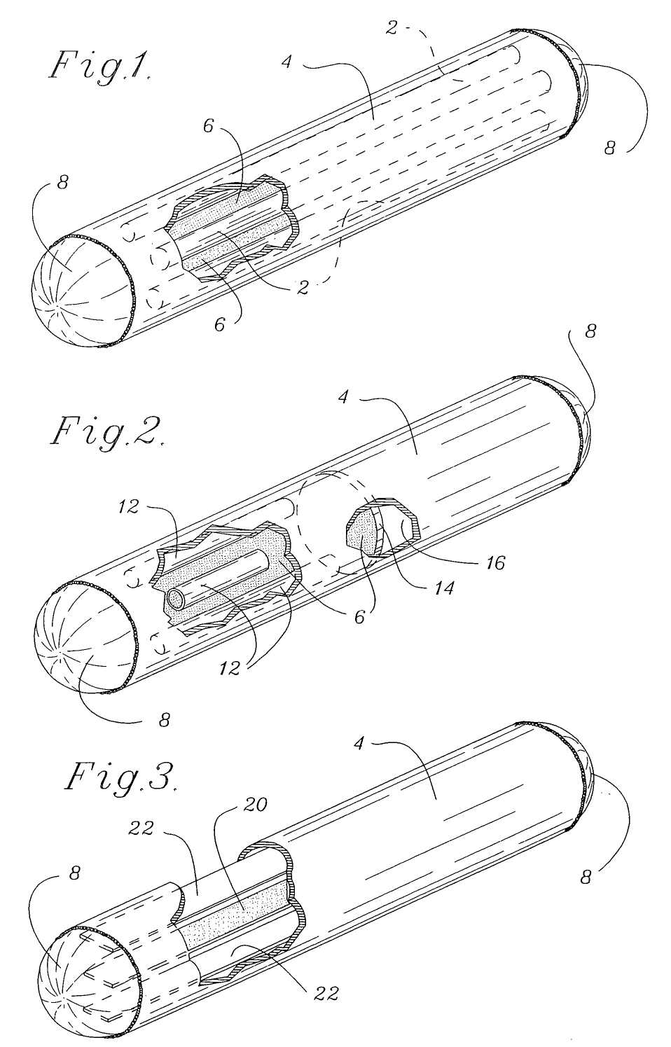

We provide an aluminum-silicon diffusion coating on a surface of a workpiece formed from an iron-, nickel-, cobalt- or copper-based alloy by simultaneous deposition of aluminum-silicon coating using a pack mix containing pure aluminum, pure silicon and an ammonium halide activator. This coating has a thickness greater than 180 microns. The coating could be applied to both sheet and tubular stock as well as complex shapes or parts. Among the workpieces to which this coating can be applied are piping, storage tanks, reaction vessels and heat exchanges, particularly those used in the petrochemical and chemical processing industries. In FIGS. 1 and 2 we illustrate the method by which the coating is formed on tubes. The components 2 to be coated are placed in a carbon steel or high temperature alloy retort 4 and are surrounded by the pack mix 6. In FIG. 1, the pack mix is a powder which has been packed inside and around the tubes 2 filling the retort 4. The ends of the retort are closed by lids 8 which may be welded or hermetically sealed. It should be understood that the retort typically will have a cooling jacket, associated piping and vents not shown in the Figures. No introduced atmosphere is necessary. However, argon or argon-hydrogen mixtures can be used as a purge gas to provide an inert or reducing atmosphere. The retort may be first heated to between 150° to 200° C. (300° to 400° F.) for one hour or longer to remove any oxygen or moisture present. Then the retort is heated to an interior temperature of 650° to 1150° C. (1200° to 2100° F.) and held at that temperature for a selected time period. That time period should range from 5 to 45 hours and will depend upon the base alloy being coated and the required depth of the diffusion coating. After the selected heating period has passed the retort is rapidly cooled and opened. Then the aluminum-silicon diffusion coated parts are removed. The coated parts are then cleaned and, if desired, also abrasive blasted.

In the first preferred embodiment of our method illustrated by FIG. 1 we fill the retort with pack mix to surround the products being coated. The pack mix contains 1-5% aluminum, 0.5-5% silicon, 0.25-3% ammonium halide activator by weight and the balance being an inert filler such as aluminum oxide. Suitable activators are ammonium fluoride, ammonium chloride, ammonium bromide and ammonium iodide. The components being coated must be free of all dirt, oil, grease, paint, rust and mill scale. In the illustrated process the tubes 2 are filled with and surrounded by pack mix to provide a diffusion coating on both the inner walls and outer walls. When only the inside surface of tubes, complex shapes or parts are to be diffusion coated, it is possible to fill the tubes or other workpieces with pack mix covering only the inside surfaces. The pack mix is held in place by metal caps or an adhesive tape. The packed tubes or other workpieces can then be loaded into an empty retort and processing will be performed as described above. Since powder is only present in the tubes or other workpieces, improved heat transfer to them will be achieved. The product to be coated can be of any desired length and may include both straight portions and return bends.

### EXAMPLE 1

Type 1018 carbon steel, type 304 austenitic stainless steel, and Alloy 800 (iron-base superalloy) samples were simultaneously diffusion coated with aluminum-silicon in a pack cementation process. The pack composition consisted of 4 wt. % aluminum, 0.5 wt. % silicon, 0.5 wt. % ammonium chloride, and 95 wt. % aluminum oxide. The process was conducted in a hermetically sealed carbon steel retort. The process consisted of heating the retort in a furnace at a temperature ranging from 1500° F.-1800° F. for 5 hours.

The diffusion coated samples were examined by standard metallographic techniques. The type 1018 carbon steel sample exhibited an average diffusion zone thickness of approximately 300 microns with no porosity and minimal grain boundary formation running perpendicular to the diffusion zone surface. Scanning electron microscopy/energy dispersive spectrometric measurements indicated a composition including 36.7 wt. % aluminum and 0.3 wt. % silicon at the diffusion zone surface. The type 304 austenitic stainless steel sample exhibited an average diffusion zone thickness of approximately 300 microns with no grain boundary formation and no porosity. The Alloy 800 sample exhibited an average diffusion zone thickness of 100 microns with no grain boundary formation and no porosity. While the coating thickness on the iron-base superalloy was less than 180 microns it is not necessary to most applications to have a thick diffusion coating on a superalloy. Moreover, carbon steel and stainless steel are less expensive than the superalloys. Consequently, a diffusion coated carbon steel or stainless steel product could provide an acceptable level of corrosion resistance at a lower cost than the same product made from a superalloy. Carbon steel or stainless steel often has better workability and is easier to weld than most superalloys. Hence, these steels are often preferred over superalloys for those reasons.

### EXAMPLE 2

Samples of a 98 wt. % copper-2 wt. % beryllium alloy were simultaneously diffusion coated with aluminum-silicon in a pack cementation process. The pack composition consisted of 4 wt. % aluminum, 1 wt. % silicon, 1.5 wt. % ammonium chloride, and 93.5 wt. % aluminum oxide. The process was conducted in a hermetically sealed carbon steel retort. The process consisted of heating the retort in a furnace at a temperature ranging from 1470° F.-1500° F. for 5 hours.

The diffusion coated samples were examined by standard metallographic techniques. The copper-beryllium samples exhibited an average diffusion zone thickness of approximately 150 microns, ranging between 100 and 200 microns, with no porosity and minimal grain boundary formation running perpendicular to the diffusion zone surface. As this alloy is used for an erosive/wear environment, hardness measurements of the diffusion zone surface were obtained. The average hardness of the diffusion zone surface was found to be 66 on the Rockwell C scale.

It is not necessary to completely fill the retort with workpieces and pack mix. As shown in FIG. 2, the items 12 to be coated are much shorter than the retort 4. Consequently, the products 12 are placed in one end of the retort 4 and surrounded with pack mix 6. A protective ceramic fiber sheet 14 is placed on the top of the pack mix while the balance of the retort remains empty. The ceramic fiber sheet 14 holds the pack mix 6 in place during heating. The heating process is preferably performed in the same manner as was described for the first embodiment. An inert or reducing gas is introduced into the space 16 above the pack mix 6 and ceramic fiber sheet 14. Since less pack mix is used than in a fully packed retort, improved heat transfer to the pack components will be achieved.

In a third embodiment shown in FIG. 3 we provide a composite pack-mix binder sheet 20 containing the proper proportions of aluminum, silicon, ammonium halide, aluminum oxide and binder. This sheet 20 is laid in the retort 4 adjacent to the plates or other components 22 to be coated. Then the retort is heated. Aluminum and silicon diffuse from the composite sheet 20 onto surfaces of plates 22 adjacent to the composite sheet 20 and the parts are further processed as described in the first embodiment.

If it is desired to coat only the inner surfaces of tubes or other hollow structure, one can use a composite insert containing the proper proportions of aluminum, silicon, ammonium halide, aluminum oxide and binder. The insert is placed into the tubes or other hollow structure whose inner walls are to be coated. The items containing inserts are capped or taped and loaded in a retort. The retort is heated as previously described to create a diffusion coating on the inner walls of the tubes or other hollow structure in the retort. Thereafter, the tubes are removed from the retort and the insert is removed from the tubes. The tubes can then be cleaned, abrasive blasted or subjected to other treatments. The use of such composite insert should provide faster heating of the items to be coated. Also, the insert and coated articles cool faster than a retort which is completely filled with powder as illustrated in FIG. 1. We have observed that a non-uniform temperature distribution can occur in the components in a retort packed as in FIG. 1. Use of an insert should minimize the effects of this condition.

We tested aluminum-silicon diffusion coatings for carbon steel pipe to compare the coatings produced when ammonium chloride is used as an activator with coatings produced when sodium chloride is used. We selected the percentage of activator as 0.5% or 2.0% to correspond to the limits disclosed and claimed by Krutenat in U.S. Pat. No. 4,500,364.

All experiments were conducted in a carbon steel retort containing ASTM A 53, 1″ IPS schedule 80 carbon steel pipe with the powder mix packed on the ID surfaces and with an inert argon atmosphere provided in the retort. Each mix was contained in one separate pipe with caps tack welded to both ends. All pipes were heated together. The heating cycle consisted of heatup of the retort in a gas fired furnace to 1800° F. for twelve (12) hours, followed by as rapid a cooling cycle as possible. Two specimens were cut from each tube, mounted, and polished according to standard metallographic procedures. Coating depths were measured and the specimens were subjected to scanning electron microscopy/energy dispersive spectrometry to determine surface aluminum and silicon composition of the diffusion coatings. The data for the two specimens was arranged to give results for each sample.

The results of these experiments are shown in Table I. The even number samples correspond to Krutenat while the odd numbered samples embody the present invention:

TABLE I

| | Mix | | | | Surface |
|---|---|---|---|---|---|
| | Composition | | | Diffusion | Al—SI |
| Sample | (wt. %) | Temp. (F) | Time (hrs.) | (microns) | (wt. %) |
| 1 | 5Al, 1 Si | 1800 | 12 | 200-230 | 16.7-2.5 |
| | 0.5 NH₄Cl | | | | |
| 2 | 5 Al, 1 Si, | 1800 | 12 | 150-180 | 9.6-1.8 |
| | 0.5 NaCl | | | | |
| 3 | 1 Al, 5 Si | 1800 | 12 | 100-130 | 6.7-2.0 |
| | 0.5 NH₄Cl | | | | |
| 4 | 1 Al, 5 Si, | 1800 | 12 | 80-100 | 7.2-2.7 |
| | 0.5 NaCl | | | | |
| 5 | 1 Al, 5 Si | 1800 | 12 | 130-150 | 4.9.-1.8 |
| | 2 NH₄Cl | | | | |
| 6 | 1 Al, 5 Si | 1800 | 12 | 80-100 | 6.4-0.8 |
| | 2 NaCl | | | | |
| 7 | 5 Al, 5 Si | 1800 | 12 | 250-280 | 20.2-3.4 |
| | 0.5 NH₄Cl | | | | |
| 8 | 5 Al, 5 Si, | 1800 | 12 | 150-180 | 13.1-2.2 |
| | 0.5 NaCl | | | | |
| 9 | 5 Al, 5 Si, | 1800 | 12 | 280-300 | 23.6-1.6 |
| | 2 NH₄Cl | | | | |
| 10 | 5 Al, 5 Si, | 1800 | 12 | 150-180 | 9.8-2.2 |
| | 2 NaCl | | | | |

It is apparent from the data in Table 1 that the pack mix containing ammonium chloride consistently produced thicker coatings. More importantly, none of the mixes containing sodium chloride produced a coating of at least 200 (8 mils) to 250 microns (10 mils). Indeed none of the prior art coatings exceeded 180 microns. Hence, a product having a coating made by the prior art Krutenat process would not be accepted by the petrochemical/chemical processing industry for much of its equipment where coatings of at least 200 microns or more are required. Ammonium chloride does provide an aluminum-silicon diffusion coating having the industry's desired diffusion coating thicknesses and surface aluminum-silicon concentrations when the mix contained 5% aluminum and 5% silicon. At this level of aluminum and silicon, the activator could be from 0.5 to 2% by weight and the mix will produce the desired coating thickness. Furthermore, the aluminum content in the coating was much greater. Sample 1 having 5% aluminum and 1% silicon produced a coating having 16.7% aluminum and a thickness of 200-230 microns. The coatings of samples 7 and 9 contained over 20% aluminum. None of the prior art Krutenat coatings came close to these aluminum levels. All of the Krutenat coatings contained less than 15% aluminum. Thus, the data indicates that the preferred pack mixes will contain at least 5% aluminum and the preferred coating will contain at least 15% aluminum. The data also indicated that a pack mix containing 1% aluminum will not produce a coating thickness greater than 180 microns. Consequently, to achieve a coating greater than 180 microns there must be more than 1% and preferably at least 5% aluminum in the pack mix.

While we have described and illustrated certain present preferred embodiments of our aluminum-silicon diffusion coated product, it should be distinctly understood that our invention is not limited thereto, but may be variously embodied within the scope of following claims.

1. A metal alloy product having a diffusion coating on at least one surface, the product comprised of:
a workpiece formed from an iron, nickel, cobalt or copper base alloy, the workpiece having at least one surface to which a diffusion coating is applied,
an aluminum silicon diffusion coating diffused into at least one surface of the workpiece, the diffused coating having a thickness at least 250 microns.

2. wherein the workpiece is selected from the group consisting of sheet, tubes, piping, heat exchanger parts, storage tanks and reaction vessels.

3. A metal alloy product having a diffusion coating on at least one surface, the product comprised of:
a workpiece formed from an iron, nickel, cobalt or copper base alloy, the workpiece having at least one surface to which a diffusion coating is applied,
an aluminum silicon diffusion coating diffused into at least one surface of the workpiece, the diffused coating having a thickness greater than 180 microns wherein the diffusion coating contains at least 15% aluminum by weight.

4. The metal alloy product of claim 1 wherein the diffusion coating is applied by pack cementation.

5. (canceled)

6. (canceled)

7. A metal alloy product having a diffusion coating on at least one surface, the product comprised of:
a workpiece formed from an iron, nickel, cobalt or copper base alloy, the workpiece having at least one surface to which a diffusion coating is applied,
an aluminum silicon diffusion coating diffused into at least one surface of the workpiece, the diffused coating having a thickness greater than 180 microns,
wherein the diffusion coating is applied by:
a. preparing a diffusion mixture consisting essentially of by weight 1% to 5% aluminum, 0.5% to 5% silicon, 0.25% to 3% ammonium halide activator and the balance an inert filler;
b. placing the diffusion mixture in a retort with the alloy product to be coated so that the diffusion mixture covers those surfaces of the product which are to be coated; and
c. heating the retort to a sufficiently high temperature to cause aluminum and silicon in the mixture to diffuse onto at least one surface of the alloy product forming an aluminum silicon coating.

8. The metal alloy product of claim 7 wherein the retort is heated to an interior temperature of from 650° to 1150° C.

9. The metal alloy of claim 7 wherein the diffusion mix contains 5% by weight of aluminum and 0.5% by weight of ammonium chloride.

10. The metal alloy of claim 7 wherein the coating is applied by surface chemical diffusion from at least one of a composite pack mix-binder sheet and a composite pack mix-binder insert which contains the diffusion mixture.

11. A metal alloy product having an aluminum-silicon diffusion coating on at least one surface, the aluminum and silicon diffusion coating being at least 200 microns thick and formed by the steps of:
a. preparing a diffusion mixture consisting essentially of by weight 1% to 5% aluminum, 0.5% to 5% silicon, 0.25% to 3% ammonium halide activator and the balance an inert filler;
b. placing the diffusion mixture in a retort with the alloy product to be coated so that the diffusion mixture covers those surfaces of the product which are to be coated; and
c. heating the retort to a sufficiently high temperature to cause aluminum and silicon in the mixture to diffuse onto at least one surface of the alloy product forming an aluminum-silicon coating having a thickness of at least 200 microns.

12. The metal alloy product of claim 11 wherein the activator is selected from the group consisting of ammonium fluoride, ammonium chloride, ammonium bromide, and ammonium iodide.

13. The metal alloy product of claim 11 wherein the coating is applied by surface chemical vapor diffusion from at least one of a pack mix-binder composite sheet and a composite pack mix-binder insert which contains the pack mixture.

14. (canceled)

15. The metal alloy product of claim 11 wherein the diffusion mix contains 5% by weight aluminum and 0.5% by weight ammonium chloride.
